(19) United States
(12) Patent Application Publication
(10) Pub. No.: US 2003/0175664 A1
(43) Pub. Date: Sep. 18, 2003

(54) Method of electronically producing a lesson plan

(76) Inventors: Eric Frangenheim, Queensland (AU); Tony Ryan, Queensland (AU)

Correspondence Address: FISH & RICHARDSON, PC, 4350 LA JOLLA VILLAGE DRIVE, SUITE 500, SAN DIEGO, CA, 92122, US

(21) Appl. No.: 10/332,260

(22) PCT Filed: Jul. 3, 2001
(86) PCT No.: PCT/AU01/00798

(51) Int. Cl. G09B 19/00

(52) U.S. Cl. 434/118

(57) ABSTRACT

A method of electronically producing lesson plans and/or teaching units and the like using a three-dimensional structure comprising different educational frameworks and strategies. A master matrix is employed, the development pages (4) of which represent a multiple learning intelligence and a cognitive learning level. Each development page comprises prompts for generating questions and/or activities, the final lesson plan being produced from selected questions and/or activities.

This invention relates to a method of electronically producing a lesson plan. In particular, although not exclusively, it relates to a method of electronically producing lesson plans and/or teaching units and the like using a three-dimensional structure comprising different educational frameworks and strategies.

### BACKGROUND TO THE INVENTION

One feature of most education systems is the wide range of results achieved by its students. The possible causes of this variation are numerous. For example, the standard of results could be due to the level of funding that an educational establishment receives. This is likely to be dependent on whether the establishment is publicly or privately funded and directly affects the resources available to both students and educators. The standards achieved by students from a particular establishment are also likely to be influenced by the geographical location of the establishment. For example, students attending an educational establishment in a remote location frequently do not achieve as highly as students attending a more centrally located one.

Another probable explanation of the broad results spectrum is the standard of the educator delivering the lessons, lectures or the like. Capabilities of educators vary both within and between educational establishments. Their age, their own education, their experience, and the length of time being an educator are some factors that may affect these capabilities. These factors are also likely to affect an educator's drive and enthusiasm and consequently the quality of the lesson, lecture or the like that they deliver. In turn, this will affect the quality of education that the students receive.

A further problem is how to fairly assess educators' capabilities. Students' results are often used as an indicator of an educator's effectiveness. However, students' results are often not an accurate reflection of how well an educator teaches his or her students.

One way of attempting to raise standards and reduce the gap between student' high and low results is to improve the capabilities of educators. One method of doing this is for educators to employ a range of teaching strategies. Various teaching strategies and concepts are known and one of these is the Multiple Intelligences Model developed by Howard Gardner, (Frames of Mind: the Theory of Multiple Intelligences. Gardner, Howard, New York, Basic Books A83). Thomas Armstrong (Thomas Armstrong, Multiple Intelligences in the Classroom, 1994, Association for the Supervisor and Curriculum Development, Alexandria, Va.) is one such educator who has promoted Gardner's work in the regular classroom -Helen-McGrath and Toni Noble (Seven Ways at Once, Classroom Strategies based on the Seven Intelligences, Adison-Wesler, Longman Australia Pty Ltd, 1995)-combined Gardner's Multiple Intelligences Model with Bloom's (Bloom, B. S. (Ed) (1956) Taxonomy of Educational Objectives, Handbook 1, cognitive domain, New York, Toronto, Longmans, Green)—taxonomy of thinking (or cognitive) processes to produce another model. The Applicant has also developed these strategies to produce a matrix of sentence stems that incorporates thinking and intelligence skills, cooperative and collaborative strategies and the multiple intelligences.

Prior to conducting a lesson, lecture or the like, educators often prepare lesson plans, lecture notes or schedules or the like. Such a plan or schedule may be followed by the educator in delivering the lesson. Alternatively, the educator and/or students may follow it when carrying out the lesson activities and exercises.

Such lesson plans or teaching units are often hand written and are consequently time-consuming to produce and amend. For example, it is likely that they must be completely re-written to incorporate even small changes to the lesson plan or teaching unit. Another problem is that the educator must rely on their own educational skills and experience to prepare an appropriate and effective lesson plan or the like. The educator does not have a framework of teaching techniques and strategies around which to form the lesson plan.

One alternative method of producing a lesson plan or the like is to use a word processing computer application. Although a word-processed lesson plan may be easily amended to incorporate changes, in comparison with a hand written version, a word processing computer application still has the drawback of not supporting the educator with teaching techniques and methods upon which to form the lesson plan.

Some educational software tools have been developed, but most of these are aimed at teaching subjects to students. The Applicant is unaware of educational software tools currently available to assist educators in the preparation of lesson plans, teaching units and the like that provide a framework of teaching techniques and strategies around which the educator may structure the lesson plans.

Thus, current methods of preparing lesson plans are time consuming to use and/or enslaving and/or only partially, if at all, use the large range of teaching and educational concepts available.

Many educators are aware of the aforementioned educational strategies and techniques, although there are many that are less familiar with them or even unaware of them. However, all educators and educational establishments would like to increase their teaching effectiveness by making full use of these concepts and strategies in a simple and efficient way. Educators wish to enhance their career prospects by improving their professional skills and by using technology. Furthermore, establishments are keen to effectively assess the standards of their educators.

### OBJECT OF THE INVENTION

It is an object of the present invention to provide a method of electronically producing a lesson plan, teaching unit or the like.

It is a further object of the invention to provide a method of electronically producing a lesson plan, teaching unit or the like, which incorporates the three structural dimensions of cognitive levels, multiple intelligences and teaching/thinking strategies.

Other objects will be evident from the following discussion.

### SUMMARY OF THE INVENTION

In one form, although it need not be the only, or indeed the broadest, form, the invention resides in a method of electronically producing a lesson plan including the steps of:

selecting at least one development page from a master matrix, each development page representing at least one intelligence and at least one cognitive level;

generating at least one formulated question or activity in the development page using sentence stems provided responsive to said selection;

selecting at least one of the formulated questions or activities; and processing said selections to produce a lesson plan or the like from the selected formulated questions and/or activities.

Preferably, said step of producing a lesson plan is according to pre-selected criteria relating to teacher objectives, student outcomes or available resources, or any combination thereof.

Preferably, the pre-selections are provided in an overview page.

Preferably, the step of producing a lesson plan further includes the step of selecting criteria governing the lesson plan from an overview page.

The overview page may include one or more of each of the following: a subject area or theme, a target group, a specific task, an educator objective, a student outcome and/or a list of available resources.

The master matrix may include columns representing intelligences and rows representing cognitive levels or teaching processes, or vice versa. Preferably, the master matrix includes seven columns representing intelligences and six rows representing cognitive levels or teaching processes.

Each development page optionally includes a first row containing at least some of the information specified in the overview page. Each development page preferably includes a second row containing the sentence stems or starters. The sentence starters combine the intelligence and the cognitive level that the development page represents on the master matrix. Each development page preferably further includes a first column stating common verbs associated with the cognitive level represented by the development page. Each development page preferably further includes a second column comprising selectable educational strategies. The strategies are preferably divided into cognitive strategies and group/cooperative strategies. The second column optionally includes a selectable page describing the selected strategy.

Selecting the formulated questions and/or activities may further include selecting a sequence in which the questions and/or activities appear in the lesson plan or the like. Optionally, a number representing a position occupied in the sequence by a question or activity may appear in the master matrix in the development page from which it originated.

### BRIEF DESCRIPTION OF THE DRAWINGS

Preferred embodiments of the invention will now be described with reference to the accompanying drawings, which are given by way of example only, in which:

FIG. 1 shows a master matrix;

FIG. 2 shows one development page from the master matrix of FIG. 1;

FIG. 3 shows a first page of a lesson plan; and

FIG. 4 shows an overview page.

### DETAILED DESCRIPTION OF THE PREFERRED EMBODIMENTS

The electronic lesson planner of the present invention may be accessed via the Internet or via an Intranet by means of a personal computer (PC), a laptop computer or the like. The lesson planner may be used online or it may be downloaded to the PC or laptop and used offline. It is envisaged that, upon the payment of a subscription fee, educators will be allocated a logon identification and password to allow access. Alternatively, the lesson planner may be provided on a storage medium, such as a CD, diskette or other storage device, whether portable or otherwise.

An overview of the elements of the electronic lesson planner will first be discussed followed by a detailed description of those elements.

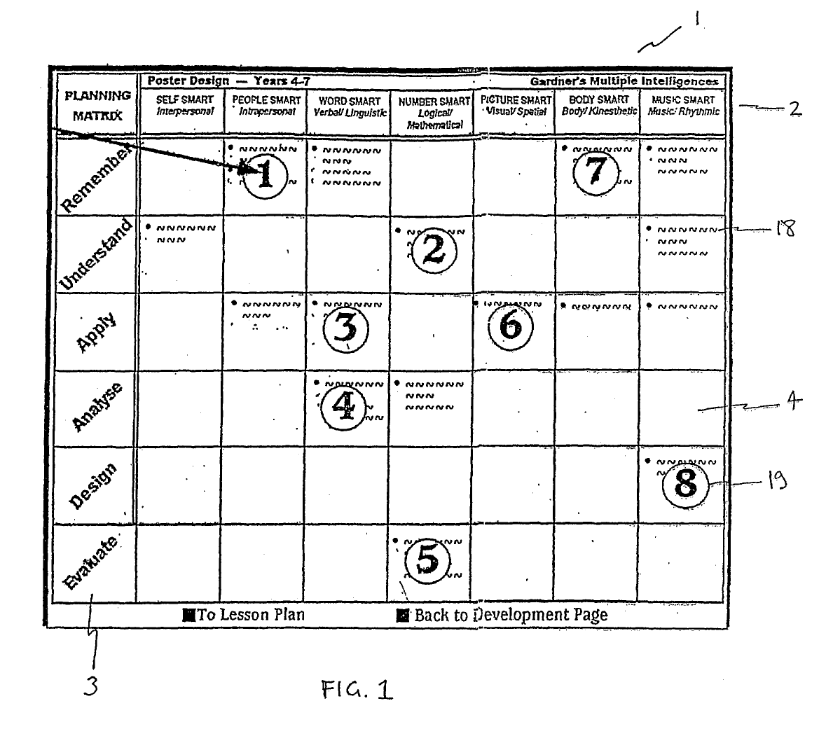

The method of the present invention utilizes a master matrix 1, as shown in FIG. 1. Preferably, the master matrix 1 comprises seven columns representing the aforementioned multiple intelligences 2 and six rows representing cognitive levels 3. The multiple intelligences and cognitive levels are known by those skilled in the art and the present invention is not limited to the order in which they appear in the matrix. Also, in an alternative embodiment, the columns may represent the cognitive levels and the rows may represent the multiple intelligences.

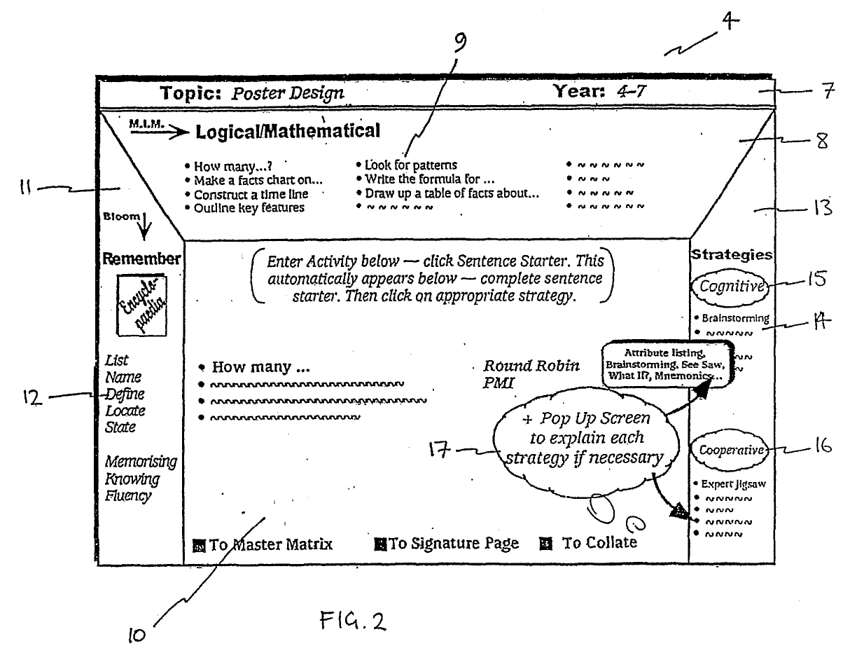

Thus, the master matrix comprises 42 development pages 4, one of which is shown in FIG. 2. Each development page 4 comprises prompting information, the nature of which being determined by the position of the development page 4 in the master matrix 1, i.e., the multiple intelligence and cognitive level which the development page represents. An educator is thus provided with a framework that aids and supports the educator in formulating questions and activities for his or her lessons.

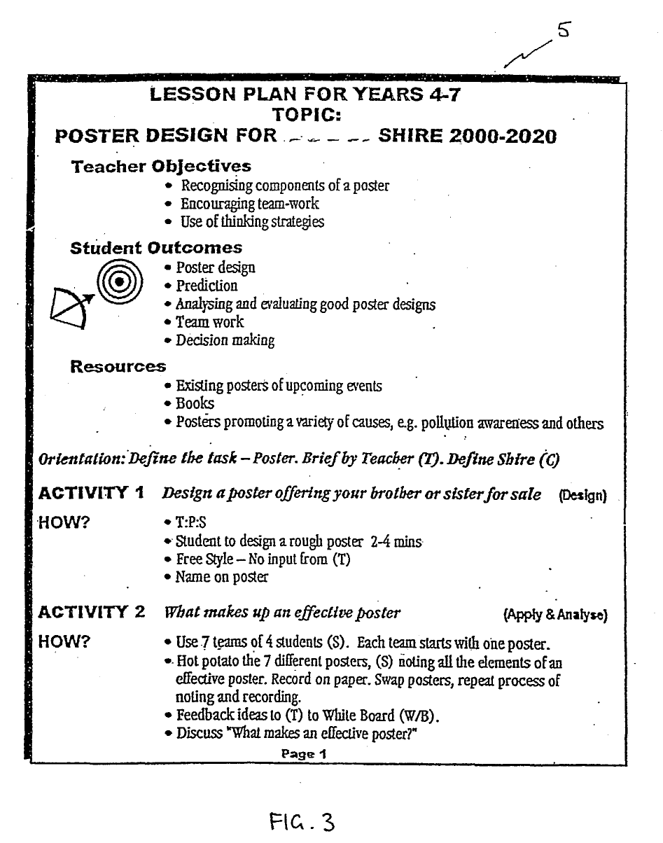

Once the educator has compiled the desired questions and/or activities in the desired development pages 4, the educator is able to compose a lesson plan 5, as shown in FIG. 3. The educator may select some or all of the formulated questions/activities to appear in the lesson plan. The educator may also choose the order in which the questions/activities appear. The lesson plan may then be printed out for use by the educator and/or the students.

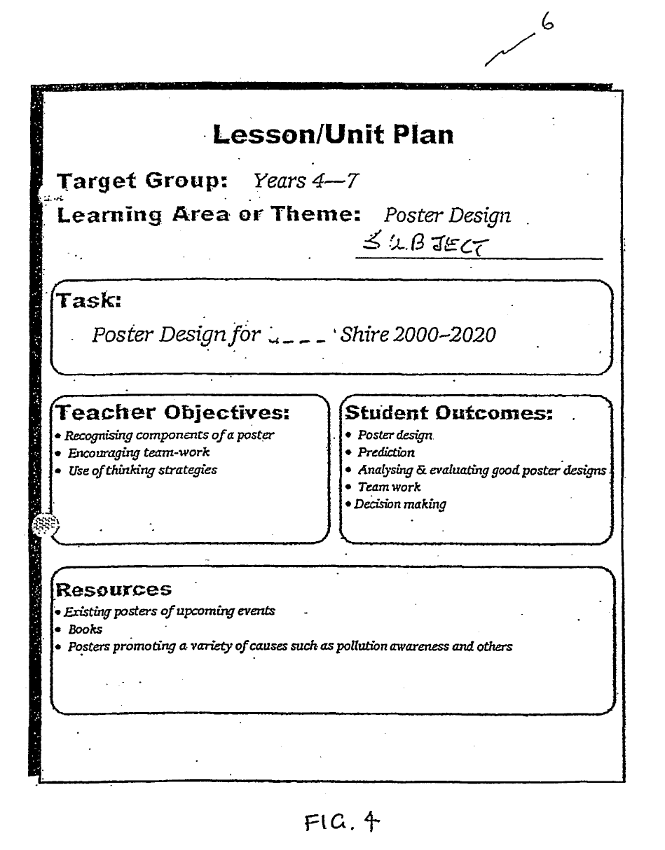

Preferably, the method of the present invention also features a overview page 6. A possible layout of the overview page is shown in FIG. 4. Although the overview page 6 is not an essential feature in the production of the lesson plan, one is preferably included. Accessing the overview page 6 is preferably the first step in preparing the lesson plan. The educator may specify various aspects of the lesson in the overview page 6 and some or all of these aspects may appear in the master matrix 1, the development pages 4 and/or the final lesson plan 5. With reference to FIG. 4, preferably, the overview page allows the educator to specify a target group, such as a year group or class, and/or a title of the lesson or teaching unit and/or a learning area or theme. The educator may also specify the task to be completed, the educator's objectives and desired student outcomes. The educator may also list the resources that are available for use in teaching or studying the lesson plan.

Once the overview page details have been submitted, they may be saved for future use and/or modification. A master matrix 1 based on the overview page may then be accessed, as shown in FIG. 1. The master matrix preferably includes the title, learning area or theme of the lesson and the target group. The educator may now select one of the 42 development pages 4 to begin formulating his or her lesson plan.

The particular development page selected depends upon which multiple intelligence 2 and which cognitive level 3 the educator wishes to focus. For example, if the educator wants to focus on the cognitive or thinking process of design and a mathematical/logical intelligence, the educator would select the development page at the intersection of the relevant row and column. Once selected, the appropriate development page 4 is displayed, as shown in FIG. 2.

The development page assists and supports the educator in formulating questions and activities that develop the selected cognitive processes and intelligences. There are three main ways in which the development page does this and these are described below.

Below a top row 7 that preferably displays the title of the lesson plan and the target group, a second row 8 displays the selected intelligence e.g. mathematical/logical. The second row also displays a series of selectable sentence stems or starters 9. A sentence starter forms a first part of a sentence that asks the student a question or requests the student to participate in an activity. The sentence starters 9 either have been developed by the applicant or derived from generally well used questions/activities employed by the educators and are a result of combining aspects of the selected intelligence 2 with aspects of the selected cognitive level or process 3. The sentence starters employ two of the three dimensions that the electronic lesson planner encourages the educator to use. Selecting one of the sentence starters 9 causes it to be displayed in a working area 10 below the second row 8.

A column 11 on the left of the working area 10 indicates the cognitive level or thinking process 3 in which the development page 4 is located and in which the educator is operating. For example, the left column 11 may have the title ‘Remember’, below which may be listed common verbs 12 which are used within this cognitive level, such as ‘list’, ‘name’, ‘locate’, ‘define’, and the like.

A column 13 on the right of the working area 10 lists strategies 14 that may be utilized when formulating the questions, tasks and activities of the lesson plan. The strategy column comprises the categories of cognitive strategies 15 and group/collaborative strategies 16. Selecting one strategy category reveals a list of strategies that fall into that category. Once a question, task or activity has been formulated, selecting one of the listed strategies causes that strategy to be displayed in the working area 10 after the formulated question, task or activity.

If an educator is not familiar with a particular strategy, an explanatory description of the strategy may be selected. This may be in the form of a pop-up screen 17 or drop-down menu or the like.

Once the questions, tasks and/or activities for a particular development page 4 have been formulated, they may be saved to the master matrix 1. With reference to FIG. 1, upon returning to the master matrix, the relevant development page may include an indicator representing one of the formulated questions or tasks. In one embodiment, the development page includes at least the beginning 18 of one of the questions formulated therein.

Once the educator has formulated all the questions likely to be needed for their proposed lesson plan, the educator may select the exact questions/activities that he or she wishes to appear in the final lesson plan. The educator may also select the sequence in which they appear in the final lesson plan. Each selected question/activity may be allocated a number 19 corresponding to the position it will appear in the lesson plan. The allocated number 19 may then be displayed in the matrix 1 to indicate both its selection and its position in the final lesson plan. A status bar or the like may also be displayed to indicate how many questions/activities the lesson planner currently contains and the positions those questions/activities occupy.

A single operation may merge the overview page 6 with the selected questions/activities to produce the final lesson plan 5, as shown in FIG. 3. In a preferred format, the details from the overview page appear first followed by the questions/activities in the selected order. The questions/activities appear as formulated in the development pages 4 including the cognitive level, the intelligence and the strategy utilized.

The overview page may also include an assessment standard for evaluation purposes. The standard may be preset for particular circumstances or may be changeable to allow adaptation to differing circumstances. For example, an assessment standard for a particular topic may be set for education at a particular level in a specified region. This standard may be different in a different region or at a different level and therefore can be altered to suit the situation.

Clearly the present invention is not limited to the aforementioned layout of the lesson plan 5 or the layout of the overview page 6 or development pages 4 which contribute thereto. Furthermore, it is envisaged that the layout of the overview page information and the layout of the development page questions/activities may differ from the layout of the same information in the final lesson plan. It is envisaged that any layouts that present the information in a clear and accessible format would be suitable.

The grid format of the master matrix 1 is a convenient way of representing the different combinations of cognitive levels 3 and multiple intelligences 2. However, it is envisaged that there may be alternative ways of representing such combinations that still fall within the scope of the present invention.

The present invention allows the educator to amend any information that he or she has entered at any stage of the production of the lesson plan.

The electronic lesson planner may be used by an educator to prepare their own lesson plans or teaching units. The stimulation provided by the lesson planner should-provide a rich source of material for any learning situation.

Alternatively, an educator may use a lesson plan prepared by another educator for his or her own lessons. For example, a head of department may produce a lesson plan for a particular subject area and year group that may be used by a number of other teachers in that department.

The electronic lesson planner may also be used by a plurality of educators to pool their ideas to produce a single lesson plan or a series of lesson plans. Furthermore, by using the electronic lesson planner, it is not necessary for all the educators to be together at one time. The master matrix 1 indicates the learning areas for which questions/activities have been formulated and those that have yet to be addressed.

An educator may select their own sequence of questions/activities from the pool developed by a range of educators. The resultant lesson plan can be tailored to their own style of teaching and thus, their own individuality is being honoured. At the same time, an educator will not only be including some of their own good ideas, but also those developed by their colleagues.

Due to the online accessibility of the lesson planner, it may be used by groups of educators within the same department, within a school, within a group of schools and/or by educators around the world.

The electronic lesson, planner may also be used by students to plan their own lessons or parts of lessons, for their own personal assignments and/or for an educator.

It is envisaged that the present invention would be suitable for all types and levels of education and tuition. It is also envisaged that the present invention may be specialized-to suit a particular application. For example, the electronic lesson planner may be tailored to produce lecture programs and tutorials for corporate or industrial applications. It is also envisaged that the electronic lesson planner could be translated into languages other than English. It is further envisaged that the electronic lesson planner could be adapted to incorporate new teaching methods and the like, as they develop.

Clearly the method of the present invention overcomes the problems of the prior art methods of producing a lesson plan. Changes to lesson plans can be made quickly and easily and the educator can systematically build up a portfolio of lesson planners that can be modified from year to year, for example, to include changes to the curriculum. Also, the electronic lesson planner provides a wide range of teaching ideas and strategy-linked questions/activities to assist the educator in producing comprehensive lesson plans.

However, the benefits of the electronic lesson planner are more numerous than merely overcoming the problems associated with the prior art.

At a glance, the master matrix 1 indicates the cognitive levels 3 and intelligences 2 that have been covered and those that are not being addressed. The educator is thus guided to use a wider spread of questions/activities and by doing so will reach more students more of the time.

Since so many strategies are provided on each development page, the educator is encouraged to place the focus of the lesson plan on the students. The strategies consistently encourage the student to engage in the learning process. Furthermore, the wide range of strategies is likely to retain the attention of the student and contribute to their motivation.

Evidently, the electronic lesson planner of the present invention is an empowering tool. The educator will feel supported in preparing lessons, lectures and the like and the combined input from a plurality of educators will lead to a cross-fertilization of ideas. Armed with a comprehensive lesson plan, the educator will be able to deliver their lessons more confidently. The competency of the educator will be demonstrated to the students who will also benefit from the improved teaching techniques and ideas.

The competency and efforts, or otherwise, of educators will also be demonstrated to the establishment by whom they are employed. The electronic lesson planner enables the establishment to monitor which educators are contributing to particular lesson plans and the like and on which strategies and areas they are focussing. This is likely to provide a more accurate assessment of the effectiveness and industriousness of their educators.

Rather than the standard of education being jeopardized by lessons of an unsatisfactory quality, the overall educational standard will be raised by the present invention due to the availability of a wide range of teaching techniques and strategies that can easily be implemented.

The programming techniques required to implement the electronic lesson planner are known to those skilled in the relevant art.

Throughout the specification the aim has been to describe the preferred embodiments of the present invention without limiting the invention to any one embodiment or specific collection of features. Persons skilled in the relevant art may realize variations from the specific embodiments that will nonetheless fall within the scope of the invention.

1. A method of electronically producing a lesson plan including the steps of:
selecting at least one development page from a master matrix, each development page representing at least one intelligence and at least one cognitive level;
generating at least one formulated question or activity in the development page using sentence stems provided responsive to said selection;
selecting at least one of the formulated questions or activities; and
processing said selections to produce a lesson plan or the like from the selected formulated questions and/or activities.

2. The method of claim 1, wherein said step of producing a lesson plan is according to pre-selected criteria relating to teacher objectives, student outcomes or available resources, or any combination thereof.

3. The method of claim 2, wherein said pre-selections are provided in an overview page.

4. The method of claim 3, further including the step of selecting criteria governing the lesson plan from an overview page.

5. The method of claim 1, wherein said sentence stems are displayed in the development page responsive to said selection.

6. The method of claim 3, wherein said overview page may include one or more of each of the following: a subject area or theme, a target group, a specific task, an educator objective, a student outcome and/or a list of available resources.

7. The method of claim 1, wherein said master matrix includes columns representing intelligences and rows representing cognitive levels or teaching processes, or vice versa.

8. The method of claim 1, wherein the master matrix includes seven intelligences and six cognitive levels or teaching processes.

9. The method of claim 3, wherein each development page includes a first row containing at least some of the information specified in the overview page.

10. The method of claim 1, wherein each development page preferably includes a second row containing said sentence stems or starters.

11. The method of claim 1, wherein said sentence stems combine said intelligence level and said cognitive level that said development page represents on said master matrix.

12. The method of claim 1, wherein each development page further includes a first column stating common verbs associated with said cognitive level represented by said development page.

13. The method of claim 1, wherein each development page further includes a second column comprising selectable educational strategies.

14. The method of claim 13, wherein said educational strategies are divided into cognitive strategies and group/cooperative strategies.

15. The method of claim 13, wherein said second column includes a selectable page describing said selected strategy.

16. The method of claim 1, wherein said step of selecting said formulated questions and/or activities further includes the step of selecting a sequence in which said questions and/or activities appear in said lesson plan or the like.

17. The method of claim 16, wherein a number representing a position occupied in the sequence by said question or activity may appear in the master matrix in the development page from which it originated.
